(19) United States
(12) Patent Application Publication
(10) Pub. No.: US 2021/0152069 A1
(43) Pub. Date: May 20, 2021

(54) PerMoFlyGen (Perpetual Motion Flywheel Generator)

(71) Applicant: James William Rich, Chapmansboro, TN (US)

(72) Inventor: James William Rich, Chapmansboro, TN (US)

(21) Appl. No.: 16/686,134

(22) Filed: Nov. 16, 2019

(51) Int. Cl. H02K 53/00; H02K 7/02

(52) U.S. Cl. CPC H02K 53/00; H02K 7/02

(57) ABSTRACT

A reconfigurable electric drive motor-electric generator device that incorporates the use of a flywheel and a continually functioning timed switch to reduce the consumption of electric power while maintaining the production of electric power in order to increase efficiency and lower environmental stress.

### BACKGROUND OF THE INVENTION

### 1. Field of the Invention

A reconfigurable device that comprises prime movers and electric machines and electronic devices to produce usable electricity.

### 2. Description of the Prior Art

Efforts have been underway to more efficiently produce usable electricity while, at the same time, reducing stress on the environment. The device incorporates continuous function of a flywheel to compensate for continual, set, timed interruptions, by use of a timed switch, in the electric current powering an electric drive motor which is coupled to an electric generator. When all said components are properly configured and adjusted, the ratio between power usage and power production will be modified, resulting in improved efficiency and reduced stress on the environment.

### SUMMARY OF THE INVENTION

The present invention provides a reconfigurable power device that comprises multiple electric machines coupled with a flywheel, or flywheel system, and a timed switch. Said timed switch is connected between a power source and the first electric machine, which is set to function as a drive motor. Said timed switch functions to continually interrupt and restore, at set intervals, the flow of electric power to said first electric machine. Said first electric machine is coupled with a flywheel or flywheel system. Said flywheel and said first electric machine are coupled with a second electric machine which is set to function as an electric generator. By continually interrupting and restoring the flow of electric power to the first electric machine at set intervals, said timed switch serves to reduce the amount of electric power consumed by said first electric machine. The function of said flywheel is to maintain the rotational speed of said second electric machine by release of stored kinetic energy while the electric power flow to said first electric machine is interrupted, in order to keep the electric charge produced by said second electric machine as near as possible to peak level while the first electric machine is “coasting”. By reducing the amount of electric power consumed by said first electric machine while maintaining the electric power production of said second electric machine, efficiency of electric power production is increased while stress on the environment is reduced. Said first electric machine will also produce usable electric current when it is “coasting”. The advantage of this device is that it may be comprised of common electric machines and prime movers of numerous kinds and types and may be powered by any kind of electric current and may produce any kind of electric current.

### BRIEF DESCRIPTION OF DRAWINGS

FIG. 1 illustrates one of the numerous possible configurations of the four primary components of the present invention, with a flywheel coupled directly between a first electric machine labeled, electric drive motor, and a second electric machine labeled, electric generator. A timed switch is placed between a power source and said first electric machine to interrupt and restore the flow of electric power to said first electric machine continually at set intervals.

FIG. 2 illustrates one of the numerous possible configurations of the four primary components of the present invention, with a flywheel coupled directly with a first electric machine labeled, electric drive motor, and said first electric machine coupled with a second electric machine labeled, electric generator, utilizing a drive belt and pulleys. A timed switch is connected between a power source and said first electric machine to interrupt and restore the flow of electric power to said first electric machine continually at set intervals.

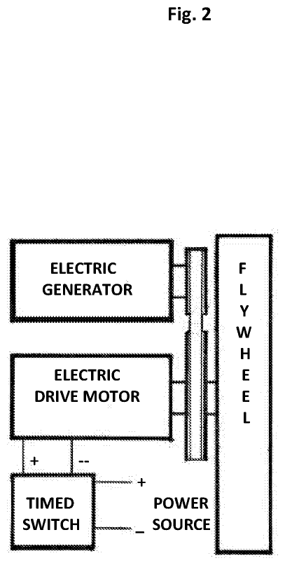

FIG. 3 illustrates one of the numerous possible configurations of the four primary components of the present invention, with a first electric machine labeled, electric drive motor, coupled directly with a second electric machine labeled, electric generator, and said first electric machine and said second electric machine each coupled directly with separate flywheels. A timed switch is connected between a power source and said first electric machine to interrupt and restore the flow of electric power to said first electric machine continually at set intervals.

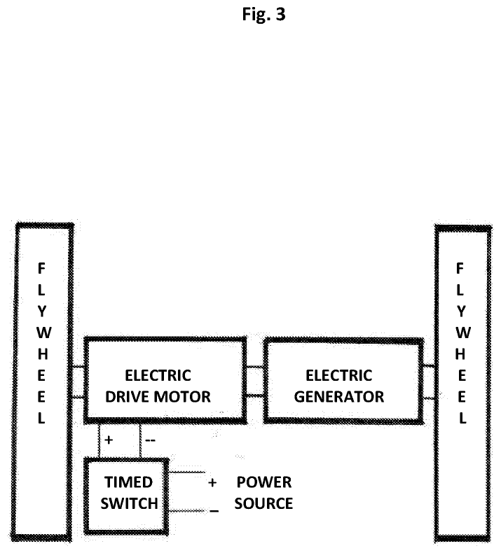

FIG. 4. illustrates one of the numerous possible configurations of the four primary components of the present invention in which a flywheel is mounted independently between a first electric machine labeled, electric drive motor, and a second electric machine labeled, electric generator, and coupled with both said electric machines by belts and pulleys. A timed switch is connected between a power source and said first electric machine to interrupt and restore the flow of electric power to said first electric machine continually at set intervals. This component configuration maximizes the potential torque of said electric drive motor and maximizes the potential rotational speed of said electric generator. This component configuration would also allow for the use of a larger flywheel or a more complex flywheel system.

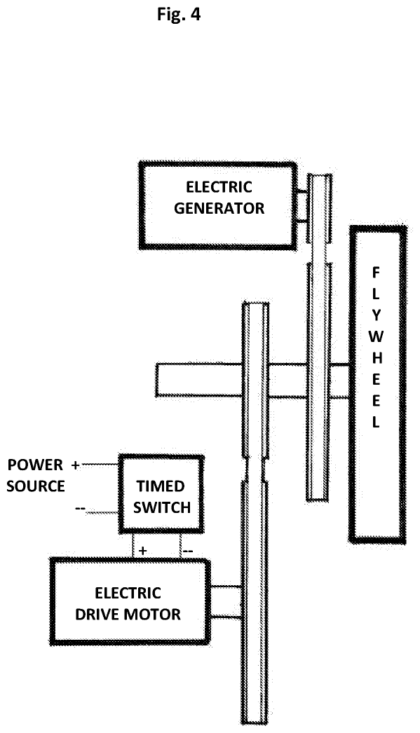

### DESCRIPTION OF THE INVENTION

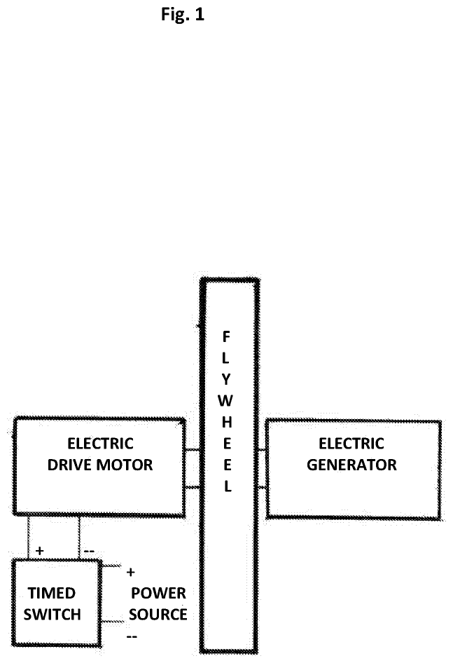

Referring to FIG. 1, the present invention, a reconfigurable power device using multiple electric machines and prime movers in accordance with the teachings of the present invention is illustrated. Two electric machines, first said electric machine labeled, electric drive motor, and second electric machine labeled, electric generator (although only two electric machines are illustrated, more than that number can be utilized) are illustrated as being coupled with a flywheel (although only one flywheel is illustrated, more than that number can be utilized). A timed switch is illustrated, connected between a power source and said first electric machine. Said timed switch functions to interrupt and restore the flow of electric power to said first electric machine continually at set intervals. The continual, timed interruption and restoration of electric power to said first electric machine reduces the amount of electric power being consumed by said first electric machine. Said flywheel, coupled with said first electric machine and said second electric machine, maintains, by release of stored kinetic energy, the rotational speed of the second electrical machine at a level necessary to maintain an electric charge level as close to peak as possible while said first electric machine is “coasting”.

What is claimed is:

1. A device for production of electric power comprising: a first electric machine, set to function as a drive motor; a flywheel coupled with said first electric machine for providing power, through release of stored kinetic energy, when electric power to said first electric machine is interrupted and restored repeatedly and continually, at set intervals, by function of a timed switch; a second electric machine, set to function as an electric generator, coupled with said flywheel and said first electric machine; resulting in constant production of electric power by said second electric machine while electric power consumption by said first electric machine is intermittent.
